(19) United States
(12) Patent Application Publication
(10) Pub. No.: US 2008/0168367 A1
(43) Pub. Date: Jul. 10, 2008

(54) Dashboards, Widgets and Devices

(76) Inventors: Imran A. Chaudhri, San Francisco, CA (US); John O. Louch, San Luis Obispo, CA (US)

Correspondence Address: FISH & RICHARDSON P.C., PO BOX 1022, MINNEAPOLIS, MN, 55440-1022, US

(21) Appl. No.: 11/620,685

(22) Filed: Jan. 7, 2007

(51) Int. Cl. G06F 3/048

(52) U.S. Cl. 715/764

(57) ABSTRACT

Dashboards and widgets are tailored for use with a variety of devices having different capabilities. In some implementations, a portable device includes a display and a processor operatively coupled to the display. The processor is operable for generating a dashboard environment including at least one widget, and for presenting the widget on the display. The widget is presented on the display based at least in part on the display type.

### RELATED APPLICATIONS

This application is related to U.S. patent application Ser. No. 10/877,968, for “Unified Interest Layer For User Interface,” filed Jun. 25, 2004, which patent application is incorporated by reference herein in its entirety.

This application is related to U.S. patent application Ser. No. 11/499,494, for “Management and Generation of Dashboards,” filed Aug. 4, 2006, which patent application is incorporated by reference herein in its entirety.

This application is related to U.S. patent application Ser. No. ______, for “Dashboards, Widgets and Devices,” Attorney Docket No. 18962-077001, filed Jan. 7, 2007, which patent application is incorporated by reference herein in its entirety.

This application is related to U.S. patent application Ser. No. ______, for “Dashboards, Widgets and Devices,” Attorney Docket No. 18962-078001,” filed Jan. 7, 2007, which patent application is incorporated by reference herein in its entirety.

### TECHNICAL FIELD

The subject matter of this patent application is generally related to graphical user interfaces.

### BACKGROUND

A hallmark of modern graphical user interfaces is that they allow a large number of graphical objects or items to be displayed on a display screen at the same time. Leading personal computer operating systems, such as Apple Mac OS®, provide user interfaces in which a number of windows can be displayed, overlapped, resized, moved, configured, and reformatted according to the needs of the user or application. Taskbars, menus, virtual buttons and other user interface elements provide mechanisms for accessing and activating windows even when they are hidden behind other windows.

Although users appreciate interfaces that can present information on a screen via multiple windows, the result can be overwhelming. For example, users may find it difficult to navigate to a particular user interface element or to locate a desired element among a large number of onscreen elements. The problem is further compounded when user interfaces allow users to position elements in a desired arrangement, including overlapping, minimizing, maximizing, and the like. Although such flexibility may be useful to the user, it can result in a cluttered display screen. Having too many elements displayed on the screen can lead to “information overload,” thus inhibiting the user to efficiently use the computer equipment.

Many of the deficiencies of conventional user interfaces can be reduced using “widgets.” Generally, widgets are user interface elements that include information and one or more tools that let the user perform common tasks and provide fast access to information. Widgets can perform a variety of tasks, including without limitation, communicating with a remote server to provide information to the user (e.g., weather report), providing commonly needed functionality (e.g., a calculator), or acting as an information repository (e.g., a notebook). Widgets can be displayed and accessed through an environment referred to as a “unified interest layer,” “dashboard layer,” “dashboard environment,” or “dashboard.” Widgets and dashboards are described in co-pending U.S. patent application Ser. No. 10/877,968, entitled “Unified Interest Layer For User Interface.”

Each year, new consumer electronic devices are introduced to the consumer marketplace. These devices, which include media players/recorders, mobile phones, personal digital assistants (PDAs), email devices, game consoles and the like, are sold in a variety of shapes and sizes. Many of these devices include display areas for presenting user interfaces and information, which can be navigated using a variety of different input devices (e.g., mouse, stylus, fingers, keyboards, virtual key pads). The display area size of some of these devices may compound the problem of navigating to an item of interest. Users of such devices will benefit from dashboard and widget configurations that take into account device limitations and attributes.

### SUMMARY

Dashboards and widgets are tailored for use with a variety of devices having different capabilities.

In some implementations, a portable device includes a display and a processor operatively coupled to the display. The processor is operable for generating a dashboard environment including at least one widget, and for presenting the widget on the display. The widget is presented on the display based at least in part on the display type.

In some implementations, a method includes: configuring a dashboard and one or more widgets to operate on a portable device; and presenting the dashboard and one or more widgets on a display of the device based on the display type.

In some implementations, a device includes a processor and a computer-readable medium operatively coupled to the processor for storing instructions. When the instructions are executed by the processor, the instructions cause the processor to generate a dashboard environment that is configured based on limitations or attributes of the device.

In some implementations, a method includes: connecting a device to a network; receiving dashboard configuration information for creating a dashboard environment on the device; and generating the dashboard environment on the device using the configuration information, wherein the configuration information is based on a characteristic of the device.

In some implementations, a device includes a processor and a computer-readable medium operatively coupled to the processor. The computer-readable medium stores a data structure that is configurable for providing access to dashboard or widget information from a dashboard or widget operating on the device, and the information conforms to a predetermined syntax.

In some implementations, a device includes a processor and a computer-readable medium operatively coupled to the processor. The computer-readable medium stores a data structure that is configurable for providing access to device information to a dashboard or widget operating on the device, and the information conforms to a predetermined syntax.

In some implementations, a computer-readable medium includes instructions, which, when executed by a processor, causes the processor to perform operations, comprising: generating a data structure operable for providing access to dashboard or widget information from a dashboard or widget operating on a device, wherein the information conforms to a predetermined syntax.

In some implementations, a computer-readable medium includes instructions, which, when executed by a processor, causes the processor to perform operations comprising: generating a data structure operable for providing access to device information to a dashboard or widget operating on the device, wherein the information conforms to a predetermined syntax.

Other implementations of dashboards and devices are disclosed, including implementations directed to systems, methods, apparatuses, computer-readable mediums and user interfaces.

### DESCRIPTION OF DRAWINGS

FIGS. 1A-1F illustrate various dashboards/widget enabled devices.

FIG. 2A is a flow diagram of an exemplary process for tailoring a widget or dashboard to a device.

FIGS. 2B-2E illustrate an exemplary process for scrolling through lists and selecting dashboards or widgets on a device with limited display area and input controls.

FIG. 2F illustrates an exemplary process for searching for dashboards or widgets using a scroll wheel.

FIGS. 3A-3C illustrate examples of input devices for invoking dashboards or widgets.

FIGS. 4A-4D illustrate an example of a process by which a user interacts with a dashboard or widget on a portable device with a limited display area.

FIGS. 4E-4H illustrate an example of a process by which a user interacts with a group of widgets on a portable device with a multi-touch-sensitive display.

FIGS. 5A-5D illustrate exemplary processes for organizing dashboards and widgets.

FIG. 5E illustrates an exemplary multi-touch-sensitive display for interacting with dashboards and widgets.

FIG. 6 is a flow diagram of an exemplary process for configuring a dashboard or widget on a device.

FIG. 7 is a block diagram of an exemplary dashboard configuration service for downloading and installing dashboard or widget configurations on devices.

FIG. 8 is a block diagram of an exemplary architecture for a device running a dashboard and widgets.

### DETAILED DESCRIPTION

### Dashboard & Widget Overview

A dashboard is an environment or layer where information and utilities can be displayed. The information and utilities can be embodied in “widgets.” Multiple widgets can exist in a dashboard at any given time. In some implementations, users can control what widgets are visible and can freely move the widgets in the dashboard. In some implementations, widgets can be displayed and hidden along with the dashboard and can share the dashboard. When the dashboard is dismissed, the widgets disappear along with the dashboard.

In some implementations, widgets are objects that users interact with when a dashboard is invoked. In other implementations, widgets can be displayed in any user interface without a dashboard, including an operating system window (e.g., a desktop) or application window, or one or more display areas (or portions thereof) in a user interface. Widgets can perform tasks for the user, such as providing a clock or a calculator. In some implementations, a widget can present useful information to the user or help the user obtain information with a minimum of required input. In some implementations, widgets are powered by known web technologies, such as Hypertext Mark-up Language (HTML), Cascading Style Sheets (CSS) and JavaScript®. Some widgets can also provide preferences, localization and system access. In the description and examples that follow, a user interacts with representations of dashboards and widgets, such as icons or thumbnail images. These representations may be referred to simply as dashboards or widgets throughout the specification and claims.

In some implementations, a dashboard is displayed such that a user can select a widget, causing the widget to be displayed without a dashboard (e.g., on a desktop user interface or application window). In such implementations, the user can click on a button or other user interface element to get back the dashboard.

Widgets can be developed using publicly available software development tools, such as Web Kit, Dashcode® and Xcode®, which are available from Apple Computer, Inc. (Cupertino, Calif.). Web Kit provides a set of classes to display web content in windows, and implements browser features such as following links when clicked by the user, managing a back-forward list, and managing a history of pages recently visited. The Web Kit simplifies the process of web page loading by asynchronously requesting web content from an HTTP server where the response may arrive incrementally, in random order, or partially due to network errors. The Web Kit also simplifies the process of displaying that content and compound frame elements each with their own set of scroll bars. Dashcode® provides developers with tools for building widgets. Xcode® is a tool for developing software on Mac OS® X, and is bundled with Apple's Mac OS® X, version 10.4 (“Tiger”) operating system.

In some implementations, a widget can be distributed as a bundle structure. A bundle is a directory in a file system that groups related resources together in one location. A widget's bundle can contain an information property list file, an HTML file, icon and default image files (e.g., portable network graphics files) and a style information file (e.g., a CSS file). In some implementations, the information property list file provides a dashboard with information about a widget (e.g., name, version, widget height and width, x and y coordinates for placement of the widget close box, etc.). The dashboard can use the information property list file to set up a space or “view” in the dashboard in which the widget can operate. The information property list file can also include access keys which provide access to external resources (e.g., the Internet).

### Examples of Dashboard/Widget Enabled Devices

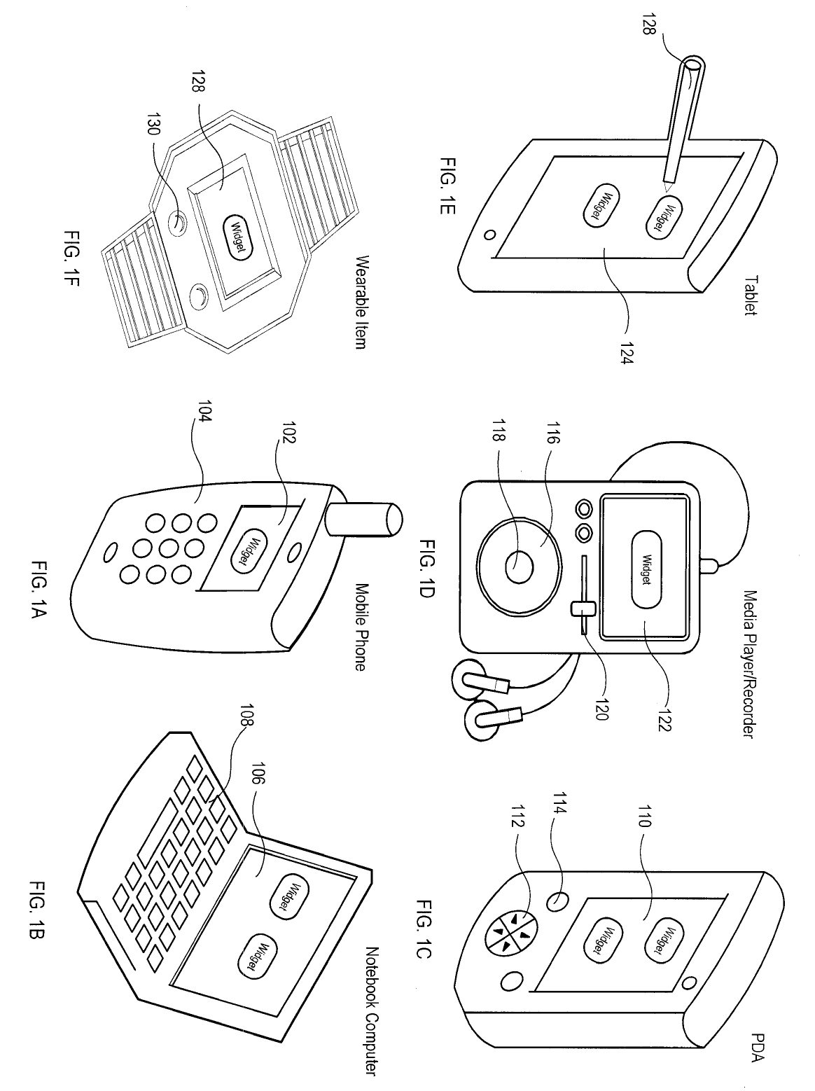

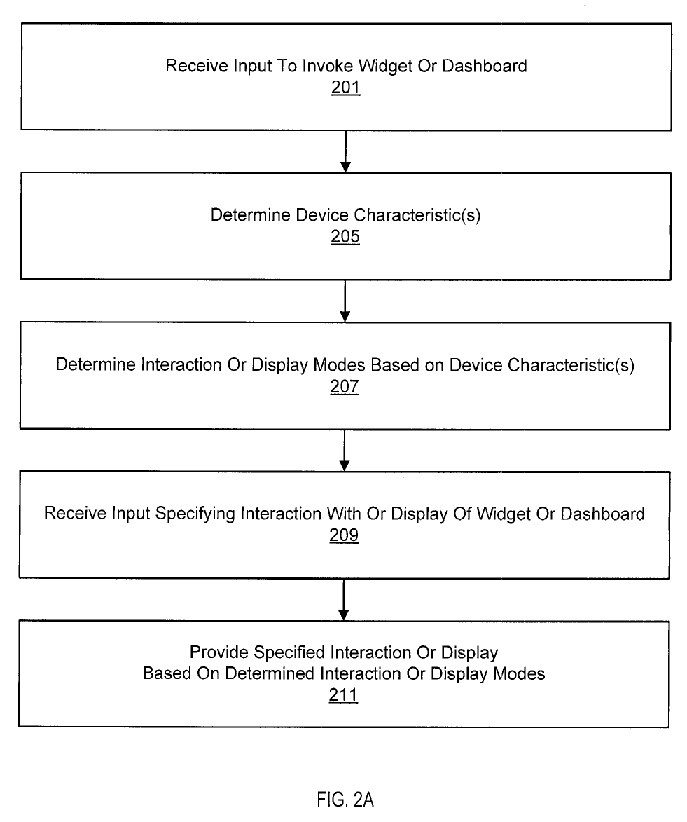

FIGS. 1A-1E illustrate various dashboards/widget enabled devices. Generally, dashboards and widgets can be operated on any electronic device capable of displaying information. Users can interact with dashboards and widgets using a variety of integrated or external input devices. In some implementations, the characteristics of the device often determine how a dashboard and widgets will be displayed, navigated, searched and interacted with by a user or program. Some characteristics include but are not limited to: the device type (e.g., portable or not portable, wireless, communication ready, Internet connectivity), the number and types of input devices (e.g., click-wheels, scroll wheels, navigation buttons, virtual keyboard, hardware keyboard, digital camera, video recorder, microphone, network connection, GPS receiver, multi-touch display), the platform type (e.g., operating system, availability of APIs, memory limitations, power limitations, communications capability, Internet connectivity, Bluetooth® or Wi-Fi® connectivity, broadband access), the available display area, etc.

As shown in FIG. 1A, a mobile phone can be a dashboard/widget enabled device. Mobile phones come in a variety of form factors and typically have a limited display area 102. Typical input devices for a mobile phone include a key pad 104 (including soft keyboards or key pads) and one or more software or hardware mechanisms, such as buttons, dials, switches, sliders, knobs, etc. In some mobile phones, the display area 102 is touch-sensitive, allowing for single and/or multi-touch input generated by one or more fingers and/or a pointing device (e.g., a stylus). Other input controls are possible for a mobile phone.

In some implementations, the mobile phone includes a touch-sensitive display and a processor operatively coupled to the display. The touch-sensitive display can be a multi-touch-sensitive display. The processor is operable for presenting a widget on the display in response to touch input. Communication circuitry (e.g., a wireless transceiver) is coupled to the processor and operable for transmitting and receiving voice or data communications. A docking station can be coupled to the mobile phone for providing power to the mobile phone when the mobile phone is docked.

In some implementations, the mobile phone can include one or more of the following: a media player, a PDA, a digital camera, a video camera, instant messaging, a search engine, Internet connectivity, wireless connectivity (e.g., Bluetooth®, Wi-Fi®, WiMAX®). All or some of these components can be associated with one or more widgets that a user can interact with to control or set parameters of the components, or display or process information generated by the components. For example, photo widget could provide controls for setting an integrated digital camera and for processing photos (e.g., making photo albums, image processing)

An example of multi-touch-sensitive display technology is described in U.S. Patent Publication No. 20060097991, for “Multipoint Touchscreen,” filed May 11, 2006, which patent publication is incorporated by reference herein in its entirety.

As shown in FIG. 1B, a notebook computer can be a dashboard/widget enabled device. Notebook computers come in a variety of form factors and typically have a larger display area 106 and more input devices than a mobile phone. A typical source of input is an integrated keyboard 108. Other typical input devices for a notebook computer include a joystick, touch pad, one or more hardware input mechanisms (e.g., buttons), etc. In some implementations, the touch-sensitive display is a multi-touch display.

As shown in FIG. 1C, a PDA can be a dashboard/widget enabled device. A PDA can be a stand alone device or integrated with a mobile phone or other device. PDAs come in a variety of form factors and typically have a larger display area 110 than mobile phones without PDA devices. A larger display area 110 enables the input of data. Other typical input devices include an x-y navigation button 112, a touch sensitive screen 110 and one or more hardware input mechanisms (e.g., a button), and gyroscopic input devices (e.g., a cordless air mouse).

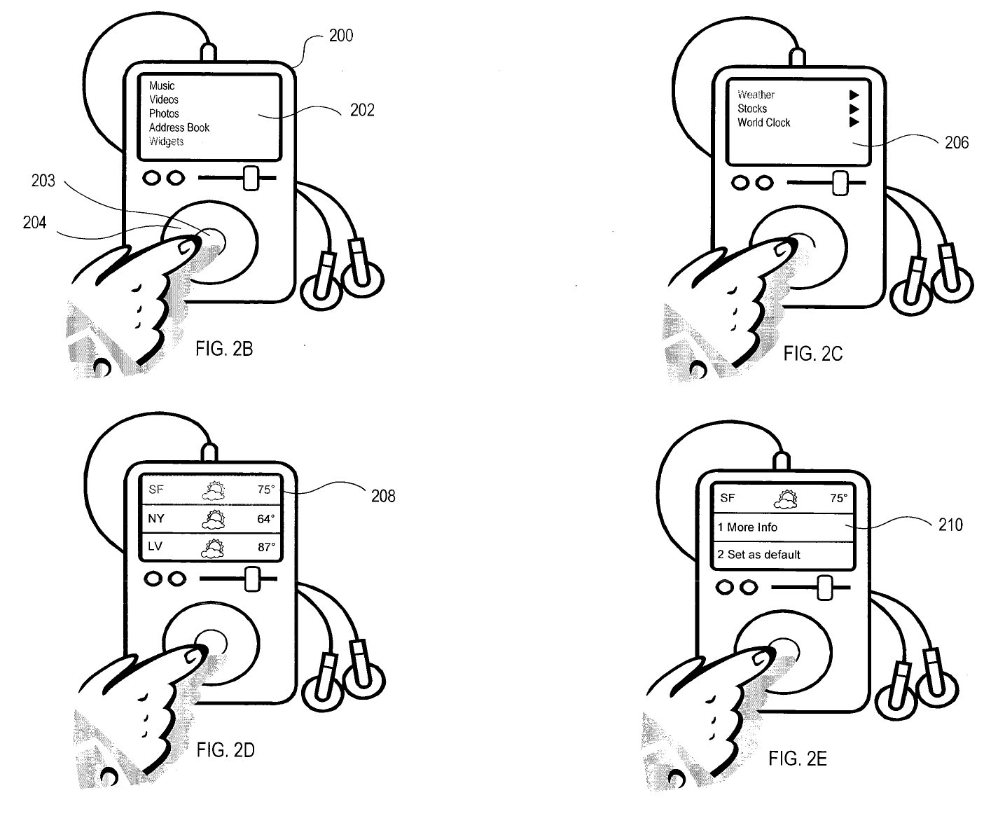

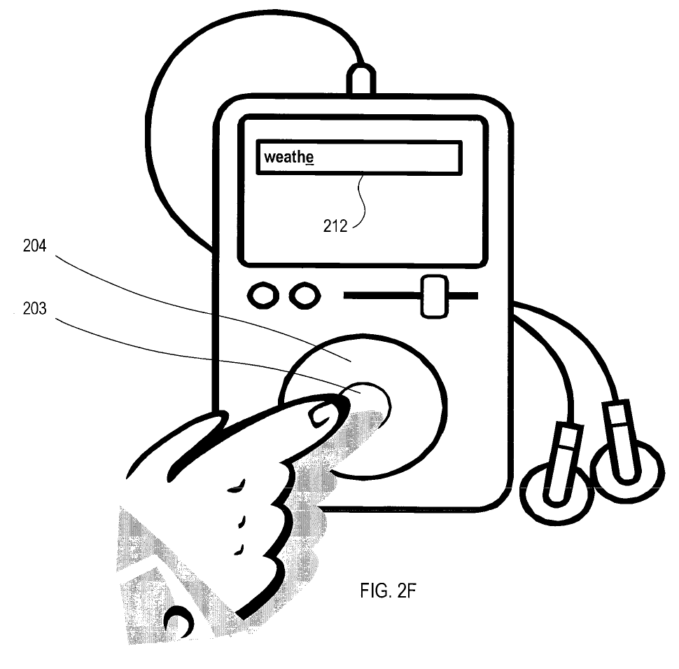

As shown in FIG. 1D, a media player/recorder (e.g., an iPod®) can be a dashboard/widget enabled device. Media player/recorders come in a variety of form factors and have display areas of various sizes. Media players can be integrated with PDA and/or mobile phone technology in a single housing. Such a device could look more like the PDA in FIG. 1C than the mobile phone shown in FIG. 1A. Typical input devices include a click-wheel, x-y navigation button, touch sensitive screen 122 and one or more hardware input mechanisms (e.g., a slider 120). The click-wheel combines a single button 118 with a touch sensitive scroll wheel 116, which can be used to efficiently and quickly navigate dashboards and widgets, as described in reference to FIGS. 2B-2E.

In some implementations, a media player includes a touch-sensitive display. A processor is operatively coupled to the display. The processor is operable for presenting a widget on the display in response to touch input. An audio system is coupled to the processor and operable for playing audio files in response to an interaction with the widget. An exemplary media player/recorder is the iPod® family of devices manufactured by Apple Computer, Inc. A docking station can be coupled to the device and provides power to the media player/recorder when it is docked. The docking station can include speakers or a video display for playing audio and/or video files when the media player is coupled to the docking station.

As shown in FIG. 1E, an electronic tablet can be a dashboard/widget enabled device. Such a device could have a larger display area 124 than a mobile phone and PDA. A typical input device is a stylus or digital pen 128 that interacts with the touch sensitive display area 124. Other typical input devices can include one or more hardware input mechanisms (e.g., a button) and a virtual keyboard.

As shown in FIG. 1F, a wearable item (e.g., a digital watch, iPod®, jewelry, clothing) can be a dashboard/widget enabled device or item. Such a device or item could have a small display area. A typical input device for a digital watch would be one or more pushbuttons 130 and/or a touch sensitive display area 128.

In some implementations, the wearable item comprises a dashboard and can provide various functions through widgets. In other implementations, the wearable item has no display, and the user interacts with the item with other senses (e.g., hearing, force feedback).

The devices illustrated in FIGS. 1A-1F are only a few examples of devices that can be dashboard/widget enabled. Each of the devices shown can have a variety of form factors and can include different display areas and input devices. In some implementations, one or more of the devices could receive speech input, which could be used with a speech recognition system to navigate and operate dashboards and widgets. In some implementations, one or more of the devices could provide visual, audio and/or tactile feedback to the user.

The devices illustrated in FIGS. 1A-1F can include displays having display areas that are entirely or partially multi-touch sensitive. For example, in some implementations a non-touch-sensitive portion of a display could be used to display content and a multi-touch-sensitive portion of the display could be used to provide input.

### Example Widget Navigation Process

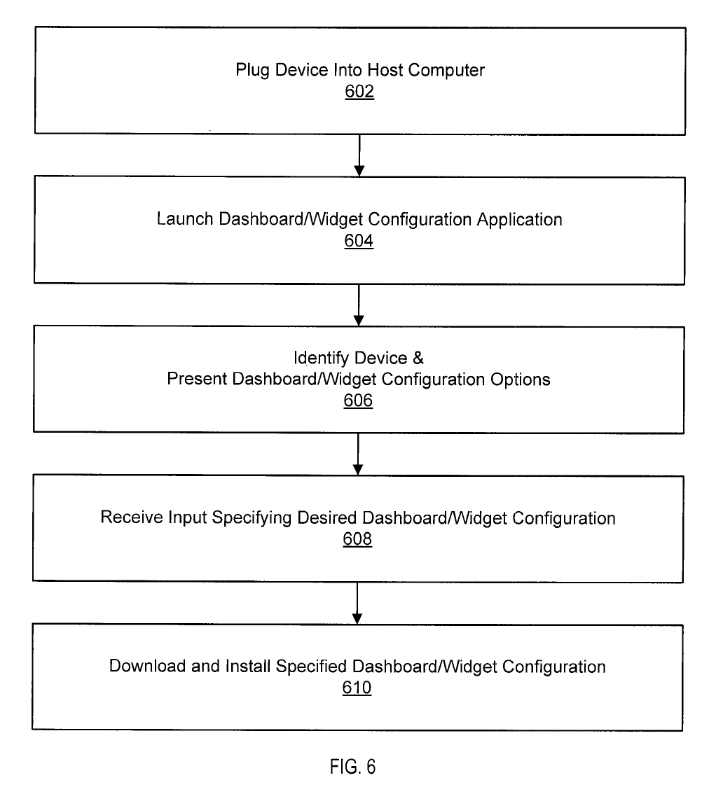

FIG. 2A is a flow diagram of an exemplary process for tailoring a dashboard or widget to a device. The process begins when input is received invoking a widget or dashboard (201). One or more characteristics of the device can then be determined (205). In some implementations, the characteristics can be determined using an Application Programming Interface (API). The API can be a data structure set-up in the memory of the device by an operating system of the device. The data structure can be used for sharing information between widgets/dashboards and the operating system. The characteristics can be determined at the time the widget or dashboard is invoked or when the widget or dashboard is loaded or installed in the device, as described in reference to FIG. 6. Device characteristics can include device type, display type or size, memory capacity, operating system, or any other characteristic of the device that can be used to tailor a widget or dashboard to operate on the device.

The process continues by determining interaction or display modes based on the determined device characteristics (207). For example, a dashboard or widget can be installed on a device and configured to communicate with the device through the API. In some implementations, a dashboard or widget can introspect the environment of a device using the API, and then configure interaction or display modes for the device using information obtained through the API. In some implementations, a dashboard or widget can provide information to the device through the API, allowing the device to engage interaction or display modes to work with the dashboard or widget based on the information provided. In some implementations, the process for determining interaction or display modes can be performed when the dashboard and widgets are loaded on the device.

In some implementations, the process continues when input is received specifying interaction with or display of widgets or dashboards (209). The process then provides the specified interaction or display based on the determined interaction or display modes (211). In some implementations, appropriate interaction or display modes are loaded onto the device at the time of loading based on information collected form the device.

FIGS. 2B-2E illustrate an exemplary process for scrolling through lists and selecting widgets on a device with limited display area and input controls. In the example shown, widgets are navigated on a media player/recorder device 200 using a click-wheel. The process, however, is not limited to media player/recorders with click-wheel input. Rather, the process can be used on a variety of devices with a variety of input devices, including the devices shown in FIGS. 1A-1F. The process is not limited to navigating multiple widgets running in a dashboard. Rather, the process can be used to navigate multiple dashboards and/or widgets running inside or outside of one or more dashboards. In addition to navigating through multiple dashboards and widgets, the process can be used to navigate through parameters and options associated with dashboards and widgets, including specifying parameters and providing input data.

Referring to FIG. 2B, a media player/recorder 200 includes a display area 202 for presenting a list of items. In this example shown, the list includes music, videos, photos, address book and widgets. The user can navigate to the widgets item by touching the wheel 204 with their finger and making a circular gesture in a clock-wise or counter-clockwise direction until the “widgets” item is highlighted or otherwise embellished to indicate its selection. The user can click the button 203 to select the highlighted “widgets” item.

In response to the click, a new list of items is displayed in the display area 206, as shown in FIG. 2C. These items include the names of widgets available on the device 200. In the example shown, the user can select from weather, stocks or world clock widgets using the click wheel in the same manner as described in reference to FIG. 2B. In this example, the user clicked on “weather” widget.

In response to the click, the “weather” widget is displayed as shown in FIG. 2D. In this example, the weather widget is displayed full screen. The temperature is displayed for San Francisco (SF), New York (NY) and Las Vegas (LV). The user can use the wheel 204 to scroll through a list of cities for which weather information is available.

Once the weather widget is displayed, the user can interact with the widget's features and controls, including the input of data. In the example shown, clicking on the San Francisco item 208 opens an options list 210, as shown in FIG. 2E. A first option on the list allows the user to view additional weather information for San Francisco and a second option allows the user to set San Francisco as a default. Selecting San Francisco as a default could, for example, cause the current temperature of San Francisco, or other weather-related information, to be displayed on the display area in a conspicuous location while the device is being used for other applications (e.g., listening to music).

The process described above is an example of how dashboard/widget navigation and interaction (e.g., workflow) can be tailored to the display area and input device(s) of a given device. The tailoring includes designing user interfaces and workflows that take advantage of input device attributes and make best use of limited display areas.

FIG. 2F illustrates an exemplary process for searching for dashboards or widgets using a scroll wheel 204. In some implementations, the user can use the scroll wheel 204 to generate search queries by entering one or more letters in a search box, then pressing the button 203 to search for dashboards/widgets having names that begin with the entered letters. Dashboards and widgets can be categorized by characteristics, properties, themes or any other criteria to facilitate organization and searching.

### Input Devices for Dashboards and Widgets

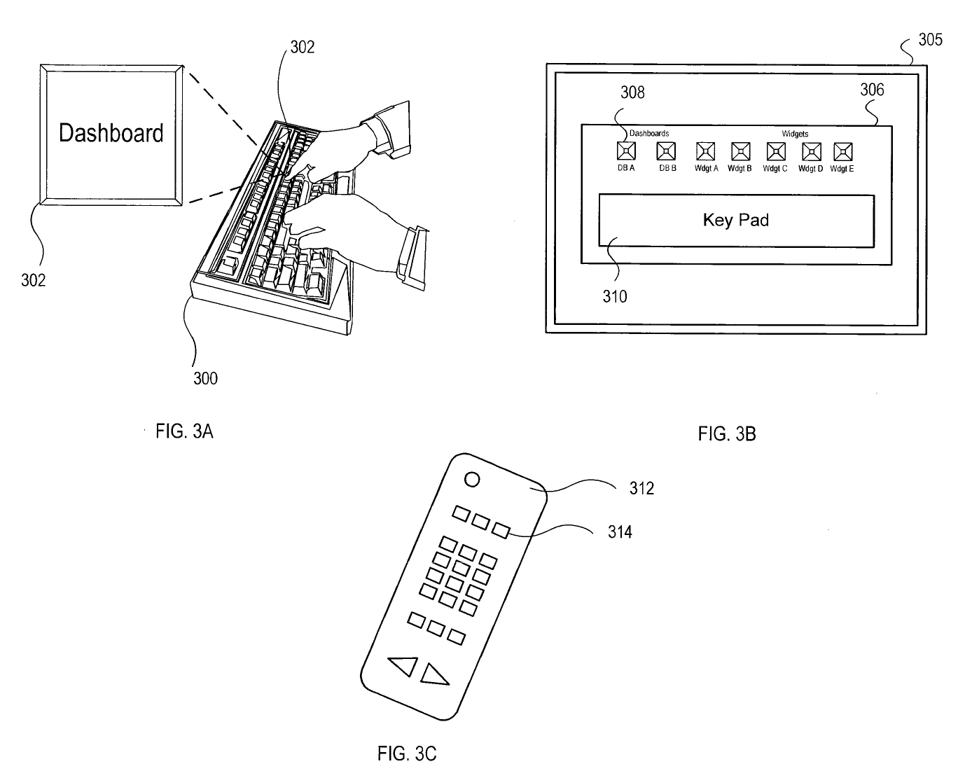

FIGS. 3A and 3B illustrate examples of input devices for invoking dashboards and widgets. In some implementations, an input mechanism can be included with a device for invoking with dashboards and devices. In the example of FIG. 3A, a user invokes a dashboard on a device by pressing a key 302 on a keyboard 300. The keyboard 300 can be integrated with or coupled to the device. In some implementations, the key 302 can be a dedicated key for invoking and dismissing a dashboard or widget. For example, the key 302 could alternately invoke and dismiss a commonly used widget (e.g., weather, stocks) by toggling the key 302. In some implementations, the key 302 (e.g., a function key) can be assigned to a specific dashboard or widget, allowing the user to create “hot” keys for their favorite dashboards and widgets. Alternatively, a key sequence can be assigned to a dashboard or widget function. Keys or key sequences can also be use to interact with various features or properties of dashboards and widgets.

FIG. 3B illustrates a virtual keyboard 306 presented on a display screen 305. In some implementations, the virtual keyboard 306 can include a virtual key pad 310 and one or more dashboard/widget buttons for invoking dashboards or widgets. For example, the user could click or touch button 308 to invoke “Dashboard A.”

In some implementations, a remote control device 312 can include one or more buttons 314, or other input mechanisms, for invoking or interacting with dashboards and widgets. The remote control device 312 can be used for digital television or media center applications (e.g., Windows® Media Center, FrontRow®). The remote control device 312 can include a display that can present widgets. The display can be touch-sensitive.

### User Interaction with Dashboard or Widget

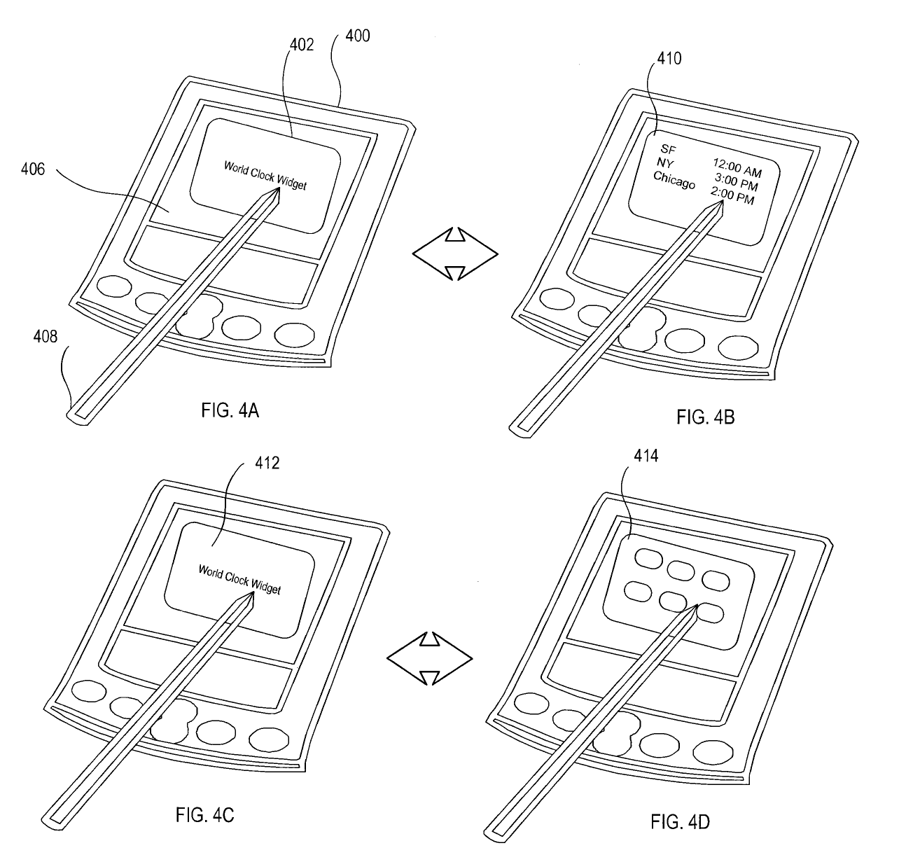

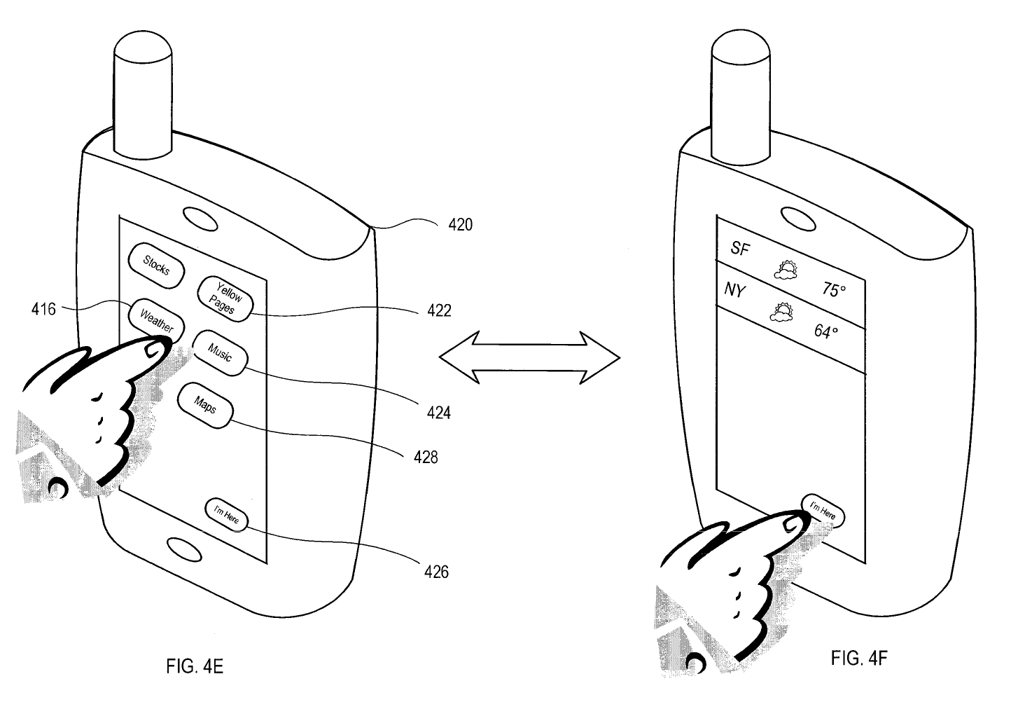

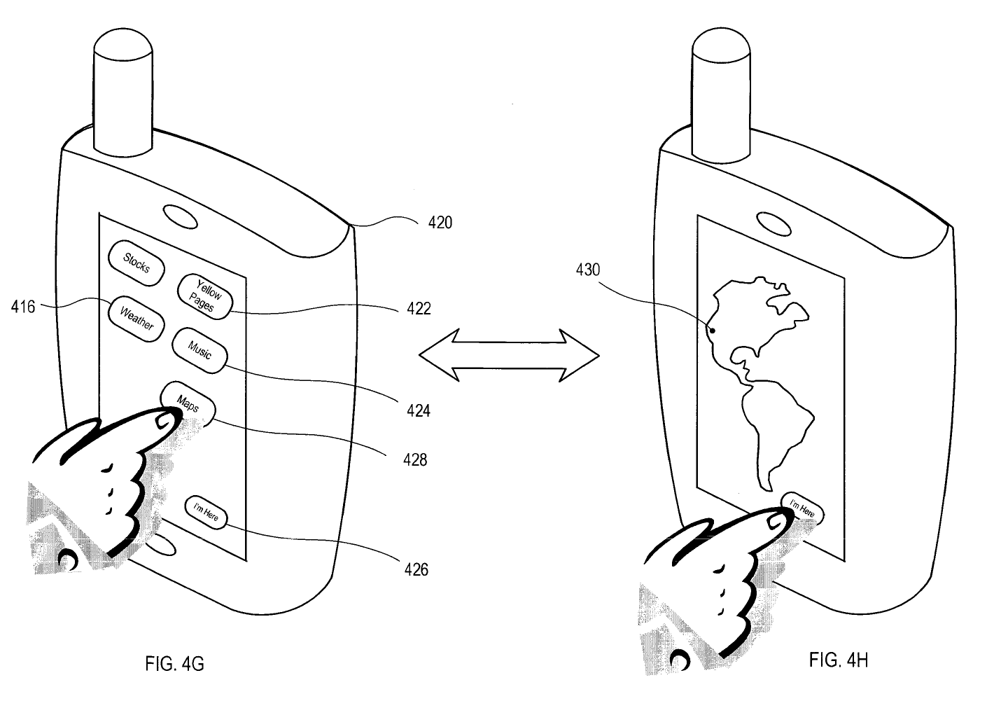

FIGS. 4A-4D illustrate an example of a process by which a user interacts with a dashboard or widget on a portable device with a limited display area. In the example shown, a user interacts with a widget 402 on a PDA device 400 using a stylus 408. The process, however, can also be applied to other types of devices (e.g., mobile phones, notebook computers).

Referring to FIG. 4A, a “world clock” widget 402 is presented on a display area 406 of device 400. The widget 402 can consume the entire display area 406 or a portion thereof. In some implementations, when the user touches the widget 402 with one or more fingers or stylus, the widget flips over and exposes additional information on its backside.

FIG. 4B shows the widget 402 in a flipped position. The flipping of widget 402 can be animated so widget 402 appears to be flipping. Other animations are also possible. For example, one corner of widget 402 could rollup or raise to reveal information. In the example shown, the user touched the widget 402, causing the widget 402 to flip over and expose a flip side 410 for displaying a list of cities and their respective local times. In some implementations, clicking or touching a city will invoke a settings dialog to allow the user to set time or other calendar functions.

Referring to FIGS. 4C and 4D, in some implementations, when a widget 412 is clicked or touched it flips to reveal icons or images of other related widgets or dashboards that can be clicked or touched to invoke corresponding dashboards or widgets.

### Location-Aware Devices

A “location-aware” device is any device that is aware of its current geographic location through the use of a positioning technology (e.g., GPS). A dashboard or widget can use positioning technology to display location-based information as an “intelligent default” or in response to a request or trigger event. Geographic information can be received by positioning technology integrated with the device or received over a network and used to filter a repository of information. When a widget is invoked or opened, the widget displays default information that is related to the user's current geographic location. For example, a world clock widget can present local time, a travel guide widget can present information about local restaurants, attractions, historic sites, events and the like, a movie widget can present local theatres, a music widget can present local music events and information about local bands, a radio widget can present local radio stations, a sports widget could present information about local teams and sporting events, a currency converter can default to local currency, a tide widget could present local tide times, a golf widget can present guidance on how to approach a particular hole on a golf course, etc.

In some implementations, the geographic location of a device and other information known by the device can be uploaded to a network website or service where it can be stored in a repository and used to provide services to other users (e.g., providing recommendations, establishing social networks, targeting advertisements).

Referring to FIGS. 4E and 4F, in some implementations, a user can select a widget from a number of widgets displayed on a location-aware device. In the example shown, the user touches a weather widget 416 on a multi-touch-sensitive display 418 of a location-aware mobile phone 420, causing the weather widget to open and consume the display 418 (or a portion thereon). Weather information displayed by the weather widget 416 can be received from, for example, a weather feed (e.g., RSS feed) through a wireless network.

In some implementations, a button (e.g., “I'm Here” button) or other user interface element 426 can be included on the display 418 for enabling the presentation of weather information by the weather widget 416 for the user's current location using positioning technology. Positioning technology can include GPS, a cellular grid, URIs or any other technology for determining the geographic location of a device. Similarly, if the user selects a yellow pages widget 422, then the user can be presented with a default display that shows the user's current location, which was derived from positioning information. If the user selects a music widget 424, then the user can be presented with a default display that shows information relating to local bands or local music events.

Referring to FIGS. 4G and 4H, in some implementations, a user can select a map widget 428 from a number of widgets displayed on a location-aware device. The user can touch the maps widget 428 causing the maps widget to display a map, which can then be manipulated by the user by touching the display and gesturing one or more fingers and/or tapping the map.

In some implementation, the map can include one or more tags 430 for geocoding. Geocoding technology can be used to assign geographic identifiers (e.g., codes or geographic coordinates expressed as latitude-longitude) to map features and other data records, such as street addresses. Users can also geocode media, for example where a picture was taken, IP Addresses, and anything that has a geographic component. With geographic coordinates, the features can then be mapped and entered into a Geographic Information System (GIS).

### Organizing Dashboards and Widgets

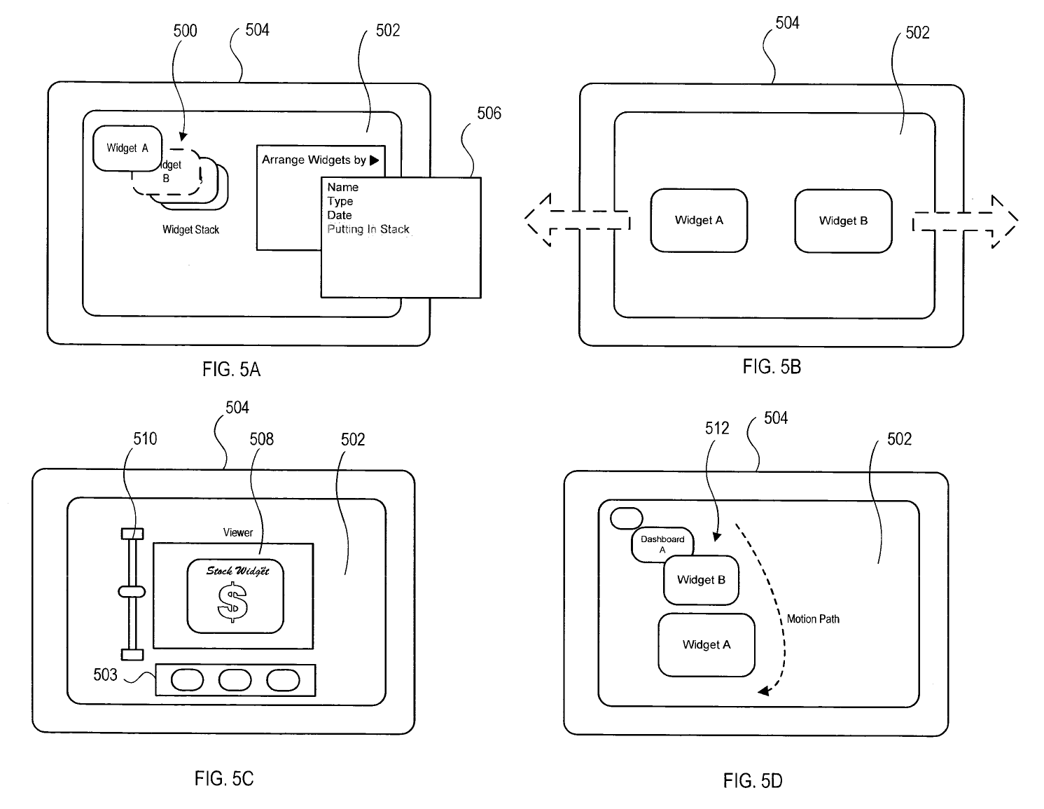

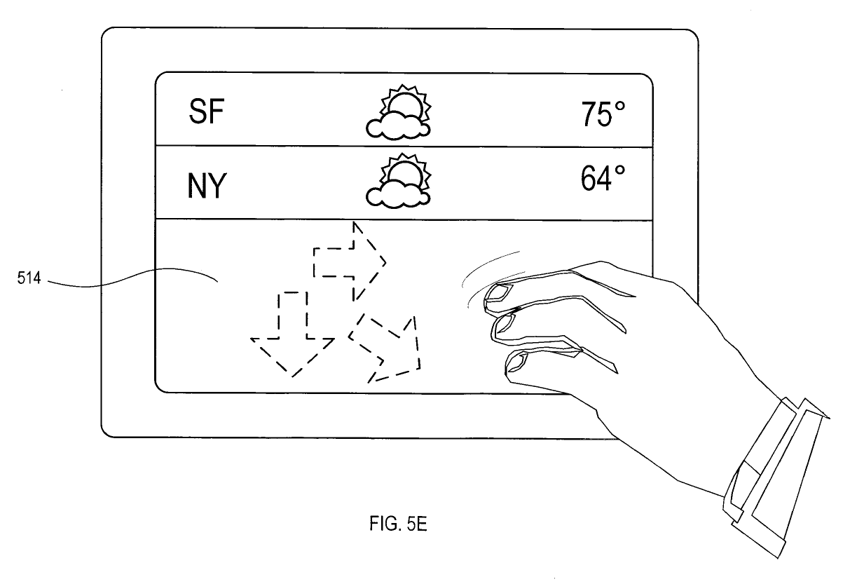

FIGS. 5A-5D illustrate examples of processes for organizing dashboards and widgets. In some implementations, limited display area and input devices determine at least in part how dashboards and widgets are organized to their accessibility to the user.

FIG. 5A illustrates a process whereby dashboards and/or widgets are organized into groupings based on defined characteristics. Generally, the process includes identifying a number of widgets or dashboards available to the device, organizing the widgets or dashboards into one or more groupings, defining at least one characteristic for each grouping (e.g., name, a common type, a user defined grouping), receiving input specifying presentation of the widgets or dashboards as a group and, in response to the input, presenting the widgets or dashboards as a group.

In the example shown, dashboards and/or widgets sharing one or more characteristics are placed in a stack 500 in a display area 502 of a device 504. The user can use one or more fingers or a stylus to search through the dashboard/widget stack 500, or to fan the dashboard/widget stack 500 to find desired dashboards/widgets. The stack 500 can be formed by selecting an option in a pull-down menu 506 or other user interface element. The pull-down menu 506 can be opened by, for example, clicking in or otherwise interacting with the display area 502.

FIG. 5B illustrates a process whereby dashboards and/or widgets are scrolled across the display area 502 of the device 504 using a finger or stylus. Generally, the process includes identifying a number of widgets or dashboards available to the device, organizing the widgets or dashboards into one or more groupings, receiving or configuring scroll settings, receiving input specifying scrolling and, in response to the input, scrolling in accordance with the scroll settings.

In some implementations, the user can scroll (horizontally or vertically) through dashboards or widgets across the display area 502 by touching the widgets and making the appropriate finger gestures in horizontal or vertical directions. When a desired dashboard/widget is found, the user can click or touch the dashboard/widget to invoke the widget. In some implementations, when the dashboard/widget is invoked the dashboard/widget is displayed to cover the entire display area 502 (full screen).

In some implementations, a user interface includes a multi-touch-sensitive display area for displaying representations of widgets together with representations for applications, and at least one of the widget representations and one of the application representations is responsive to multi-touch input. In some implementations, a widget can be opened in a user interface (e.g., in response to multi-touch input) and expanded to consume substantially all of the multi-touch-sensitive display area.

FIG. 5C illustrates a process whereby icons or images corresponding to dashboards or widgets are presented in a viewer 508. Generally, the process includes identifying a number of widgets or dashboards available to a device, organizing the widgets or dashboards into one or more groupings, identifying a viewer, identifying constraints associated with the viewer (e.g., display size, number and types of viewer controls, sound enabled), configuring the widget or dashboard for display in the viewer based on the constraints (e.g., scaling), receiving input specifying an interaction with a viewer control, in response to the input, presenting the widgets or dashboards in the viewer 508.

In some implementations, a user can scroll through available dashboards and/or widgets using a viewer control 510 (e.g., a scroll bar). In the example shown, the viewer control 510 is a scroll bar that allows the user to manually scroll through dashboards or widgets. Other controls can be added to the scroll bar to provide for incremental or continuous scrolling. In some implementations, sound effects can be played for the user (e.g., a clicking sound) during scrolling, or a synthesized speech engine can output the name of a dashboard or widget when its icon or image appears in the viewer 508.

In some implementations, a dashboard/widget configuration bar 503 can included on the display area 502. The configuration bar 503 can include active dashboards and/or widgets. The configuration bar 503 can include controls for scrolling through widgets. If a user taps on a widget icon, an active widget corresponding to the icon can be displayed full screen. If the user taps on an inactive widget icon, the corresponding widget can be invoked. The configuration bar 503 can include additional features, as described in U.S. patent application Ser. No. 10/877,968, for “Unified Interest Layer For User Interface.”

FIG. 5D illustrates a process whereby dashboards and/or widgets are animated to parade across the display area 502 of device 504 along a motion path 512. Generally, the process includes identifying a number of widgets or dashboards available to a device, organizing the widgets or dashboards into one or more groupings (e.g., a play list), identifying the motion path 512, identifying transitions (e.g., animations) for widgets or dashboards in the parade, receiving input to play the parade and, in response to the input, playing the parade based on the play list and the transitions.

Icons or images corresponding to dashboards and widgets can be animated to follow the motion path 512 using known technology, such as Quartz Composer® provided with Mac OS® X version 10.4, or similar graphics development tools. When the user finds a desired dashboard or widget, the user can click or touch the icon or image in the parade, which invokes the dashboard or widget. In some implementations, when the dashboard or widget is clicked or touched the dashboard or widget is displayed over the entire display area 502. The animated parade can be started by clicking or touching empty space in the display area 502 near the parade. The parade can be stopped by clicking again on the empty space or an icon or image to select a dashboard or widget.

FIG. 5E illustrates an exemplary multi-touch-sensitive display 514 for interacting with dashboards and/or widgets. In the example shown, a user uses one or more fingers to scroll between open widgets by making the appropriate gestures. For example, the user can touch the display 514 of a device (e.g., a mobile phone) with one or more fingers and make a gesture in any direction in the plane of the display 514 to scroll through open or closed widgets or dashboards, or to access features of same. Thus, in some implementations the dashboard environment can extend beyond the viewable area of the display 514. Scrolling can be horizontal, vertical and diagonal. The speed of the scrolling is controlled by the speed of the finger gestures made by the user. The user can select an item by tapping one or more times on the display 516 at the location of the item. The scrolling can be animated to give the impression of friction or other properties. For example, the user can make a single touch and gesture and widgets will be continuously scrolled by the display 514 in a Rolodex® manner and slowly de-accelerate to a stop. Other animations are possible.

### Dashboard/Widget Configuration Process

FIG. 6 is a flow diagram of an exemplary process for configuring a dashboard/widget on a device. Due to the wide variety of dashboard/widget enabled devices, a service can be provided for downloading configuration data to a device for customizing dashboards and/or widgets.

In some implementations, the process begins when the user plugs a device into a port of a host computer (602). A host computer is any computer that connect to a device or network. For example, the user may have a desktop computer with Internet or wireless connectivity. The user can attach the device to the host computer using Universal Serial Bus (USB), Firewire® cable, Ethernet or any other bus technology. Alternatively, a device may have a network interface adaptor (e.g., Ethernet, wireless transceiver) or a modem (e.g., cable or DSL modems) that allow the device to connect directly to a network.

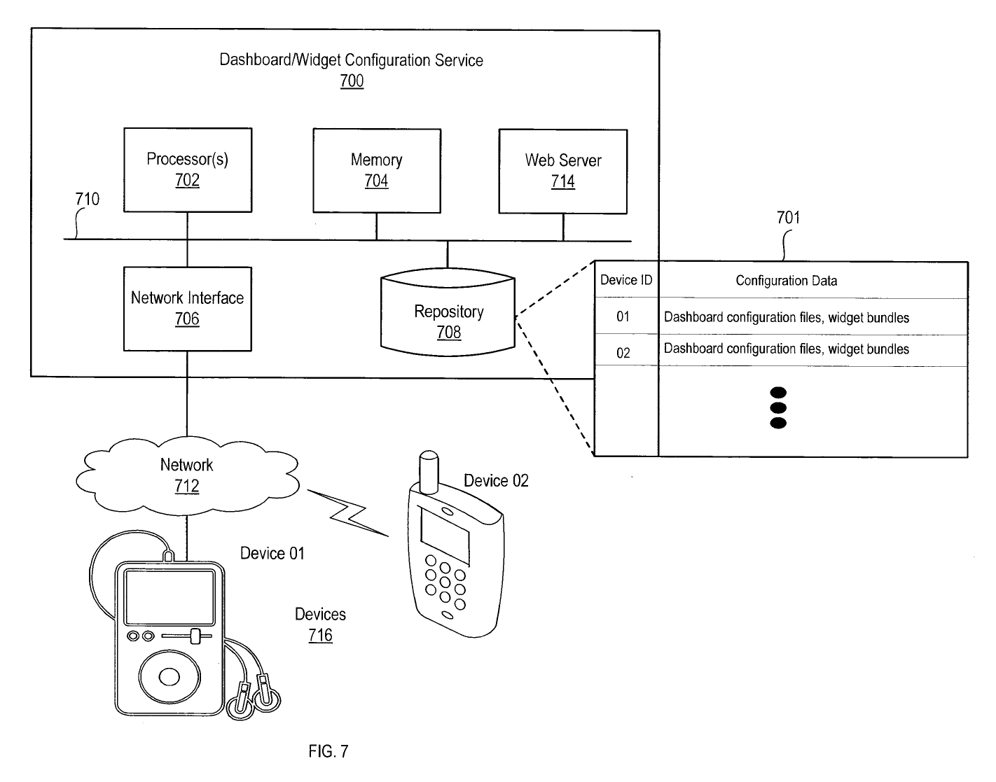

An application, operating system or driver running on the host computer detects the physical connection and automatically launches a dashboard/widget configuration application (604). In some implementations, the configuration application automatically opens a browser on the host computer and uses a uniform resource identifier (URI) to steer the user to a web site operated by a configuration service, as described in reference to FIG. 7. The device provides a device identifier (ID) to the host computer, which forwards the device ID to the configuration service. In some implementations, the device ID is used by the configuration service to index a database of dashboard/widget configuration information that has been specifically tailored to conform to the device.

The configuration service identifies the device by its device ID and presents the user with dashboard/widget configuration options (606). The options can be presented in, for example, a web page set-up dialog provided by a web server operated by the configuration service. The options can include, for example, various dashboard configurations and/or widget bundles including various numbers and types of widgets. In some implementations, the configuration service provides users with tools for managing and generating dashboards, as described in U.S. patent application Ser. No. 11/499,494, for “Management and Generation of Dashboards.”

In some implementations, the user is presented with set-up dialog for providing input specifying a desired dashboard/widget configuration. When the input is received (608), the configuration service downloads the specified configuration information to the device through the host computer, where the configuration can be automatically or manually installed (610).

In some implementations, dashboard-enabled devices do not have any network interfaces and pull dashboard/widget information from the host computer for use offline.

### Dashboard/Widget Configuration Service

FIG. 7 is a block diagram of an exemplary dashboard configuration service 700 for downloading and installing dashboard/widget configurations 701 on devices. In some implementations, the configuration service 700 generally includes one or more processors 702, memory 704, a network interface 706, a repository 708 and a web server 714. The configuration service 700 can be a web site that includes one or more servers. The repository 708 is used to store configuration data 701 and other information for running the configuration service 700. The configuration data 701 can include information for displaying widgets (e.g., widget width and height) and for controlling the functionality of dashboards and widgets (e.g., work flows, navigation, access to resources, security).

The repository 708 can be a database implemented on one or more storage devices (e.g., hard disks, optical disks, memory, storage area network (SAN)) using known database technology (e.g., MySQL®). The web server (e.g., Apache® web server) 714 serves web pages to devices 716 through the network interface 706 (e.g., network interface card, router, hub) and network 712 (e.g., the Internet, wireless network). Memory 704 can be any computer-readable medium (e.g., RAM, ROM, hard disks, optical disks, memory modules). Memory 704 can store instructions for execution by rocessor(s) 702 (e.g., Intel® Core™ Duo processors). The instructions can be for an operating system (e.g., Mac OS® X server, Windows®NT, Unix, GNI/Linux), network communication software (e.g., TCP/IP software), applications and/or any other software used by the configuration service 700.

As described in reference to FIG. 6, a user can connect a device 716 to network 712 either directly or through a host computer. Upon connection, the user's browser can be automatically opened and the user can be directed by a URI to a website operated by the configuration service 700. The device has a device ID that can be used by the configuration service 700 to index the repository 708 and identify configuration data 701 associated with the device ID. In the example shown, “device ID 01” is associated with a particular brand and model of a media player/recorder. Similarly, the “device ID 02” is associated with a particular brand and model of mobile phone. In some implementations, there can be multiple configurations available for the same device ID. For these cases, the user can be presented with a set-up dialog that allows the user to specify a configuration for the device.

The configuration service 700 allows user's to create custom configurations, which can be downloaded and installed on a variety of devices. In some implementations, the user can create a single “template” configuration which the configuration service 700 can conform to the device specified by the device ID. The conforming ensures that the dashboard and widgets operate within device constraints (e.g., limited display area or memory) and/or take advantage of the unique attributes of the device (e.g., click-wheel input).

### Dashboard/Widget APIs

In some implementations, dashboards and widgets interact with an API. A dashboard or widget can be installed on a device and configured to communicate with the device through the API. In some implementations, a dashboard or widget can introspect the environment of a device using the API, and then configure itself to work on the device using information obtained through the API. In some implementations, a dashboard or widget can provide information to the device through the API, allowing the device to configure itself to work with the dashboard or widget.

In some implementations, the API specifies a “presentation mode” that describes the display capability of a device. For example, a dashboard or widget can learn the “presentation mode” of a device and configure itself to comply with the mode. In some implementations, the “presentation mode” could include a “large display” configuration, a “medium display” configuration and a “small display” configuration, which correspond to the display size of the device. For example, in a “small display” configuration, the dashboard or widget can scale icons and images to fit the small display.

In some implementations, the API specifies an “input capability” that describes the input controls available on a device. A dashboard or widget can learn of the input capabilities of a device through the API and configure itself to work with those capabilities. For example, if a device includes a scroll wheel, a widget can configure itself to allow scrolling that is optimized for a scroll wheel.

### Exemplary Device Architecture

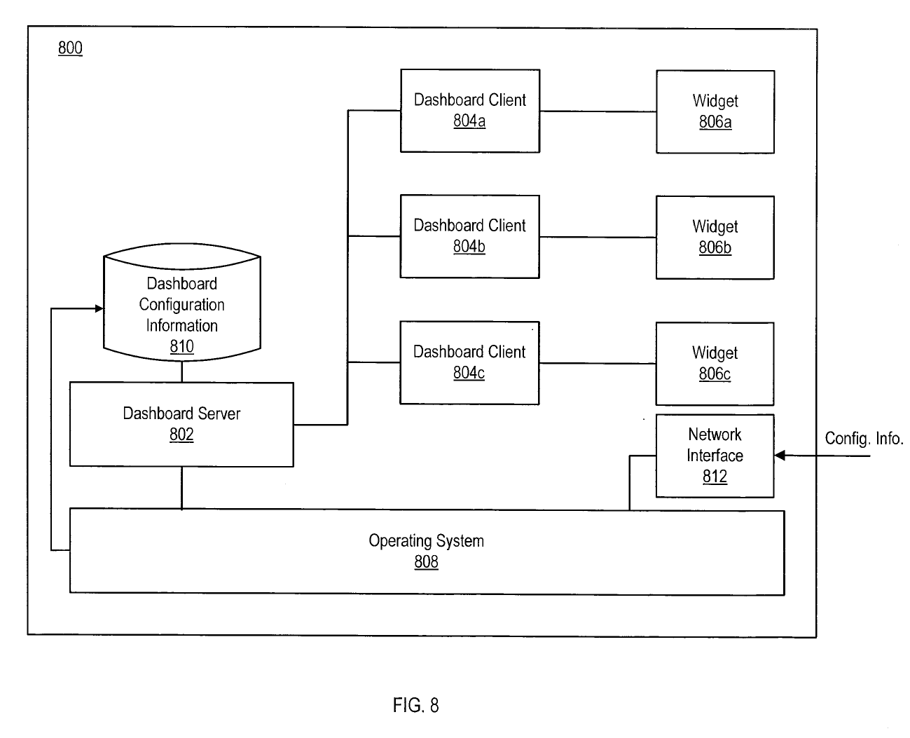

FIG. 8 is a block diagram of an exemplary run time architecture 800 for a device running a dashboard and widgets. In some implementations, the architecture generally includes a dashboard server 802, dashboard clients 804, widgets 806, an operating system 808 (e.g., Mac OS® X, Windows® XP, Linux® OS), dashboard configuration information repository 810 and network interface 812 (e.g., network interface card, modem).

In some implementations, configuration information is received through the network interface 812 and stored in the repository 810. The dashboard server 802 uses the configuration information to configure one or more dashboards and/or widgets for a device. In some implementations, the dashboard server 802 is a process that manages one or more dashboard user interfaces, including the features described in reference to FIGS. 2-5. The dashboard server 802 also handles the launching of widgets 806.

The dashboard clients 804 are processes that provide the glue between the dashboard server 802 and individual widgets 806. In some implementations, each widget is run inside a separate dashboard client 804. For example, the clients 804 can provide views in the dashboard for displaying a user interface. In the example shown, the dashboard server 802 launches one client 804 per running widget 806 which provides a sandbox so that the widget 806 does not affect other widgets or applications.

The dashboard server 802 manages widgets 806. If a widget 806 crashes, the widget 806 can be automatically restarted so that the widget reappears in the dashboard. If a widget 806 misbehaves (e.g., crashing more than x times in a row), the widget 806 can be automatically removed from the dashboard.

Widgets 806 can be displayed in the dashboard created by the dashboard server 802 or in other user interfaces, such as a desktop or in a browser or application window (e.g., Safari®). In some implementations, a widget 806 can be stored as a “bundle” of files in the repository 810 (e.g., hard disk, RAM, ROM, flash memory). A bundle is a directory that groups all the needed resources for the widgets 806 together in one place. Widget bundles can be named with a unique extension (e.g., .wdgt).

In some implementations, a given widget contains at least the following files: 1) an HTML file defining a user interface for the widget; 2) a default background image that can be displayed by the dashboard while it loads the widget; 3) an icon image used to represent the widget; and 4) a property list file that contains the widget's identifier, name, version information, size, and main HTML page and other optional information used by the dashboard. The bundle can include other files as needed for the widget, include but not limited to CSS files and JavaScript® files.

In some implementations, a scripting language (e.g., JavaScript®) can be used to provide dynamic behavior in widgets. A script can be distinguished from a program, because programs are converted permanently into binary executable files (i.e., zeros and ones) before they are run. By contrast, scripts remain in their original form and are interpreted command-by-command each time they are run.

JavaScript® in a dashboard can work the same way as it does in any browser with the addition of a widget object. The widget object allows the following actions: 1) access to a user preferences system; 2) flipping a widget over to access preferences or other information and links; 3) respond to dashboard activation events; 4) open other applications; and 5) execute system commands, such as shell scripts or command-line tools.

For widgets built using Web Kit, any Internet plug-in can be run from within the widget. For example, a widget could display a movie using a QuickTime® Internet plug-in. In some implementations, widgets can interact with an application by loading a plug-in and using, for example, a JavaScript® object to bridge JavaScript® with an application programming language (e.g., Objective-C).

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications may be made to the disclosed implementations and still be within the scope of the following claims.

What is claimed is:

1. A portable device, comprising:
a display; and
a processor operatively coupled to the display, the processor operable for generating a dashboard environment including at least one widget, and for presenting the widget on the display, wherein the presenting of the widget on the display is based at least in part on the display type.

2. The device of claim 1, wherein the presenting of the widget is based at least in part on the display size.

3. The device of claim 1, wherein the device is from a group of devices consisting of a mobile phone, a computer, a personal digital assistant, a media player, an electronic tablet, a dashboard or widget device, a remote control and a wearable item.

4. The device of claim 1, further comprising:
an input device operatively coupled to the processor for interacting with the dashboard or widget, wherein the dashboard or widget are configured to interact with the input device.

5. The device of claim 4, wherein the input device is from a group of input devices consisting of a scroll wheel, a click-wheel, a touch screen, a multi-touch screen, a button, a keyboard, a user interface element, a mouse, a joystick, a gyroscopic device, a digital camera, a video camera, a network connection, a microphone, a remote control and a microphone.

6. The device of claim 4, wherein the input device is a scroll wheel configurable for scrolling through one or more lists associated with the dashboard environment or the widget.

7. The device of claim 4, wherein the input device is a scroll wheel configurable for generating a search query.

8. The device of claim 4, wherein the input device is a keyboard including one or more keys for invoking the dashboard or widget.

9. The device of claim 4, wherein the input device is a remote control including one or more input mechanisms for invoking the dashboard or widget.

10. The device of claim 4, wherein the widget is responsive to a user interacting with the widget on the display.

11. The device of claim 10, wherein the widget is configured to expose a flip side in response to the user interacting with the widget.

12. The device of claim 11, wherein the widget is configured to present information on the flip side.

13. The device of claim 10, wherein the widget is configured to present a second widget on the flip side, which can be interacted with by a user to invoke the second widget.

14. The device of claim 1, wherein the display presents a plurality of widget representations, at least one of which invokes a corresponding widget in response to a user interaction with the representation.

15. The device of claim 14, wherein the corresponding widget is from a group of widgets consisting of a stocks widget, a yellow pages widget, a weather widget, a music widget and a map widget.

16. The device of claim 1, wherein the processor is operable for generating a dashboard environment including a number of widgets and for presenting the widgets in a stack on the display.

17. The device of claim 16, wherein the stack can be searched.

18. The device of claim 17, wherein the stack can be arranged in response to user input.

19. The device of claim 1, wherein the processor is operable for generating a dashboard environment including a number of widgets and for presenting the widgets in a parade on the display.

20. The device of claim 19, wherein the parade is animated to follow a motion path on the display.

21. The device of claim 1, wherein the processor is configurable for generating a dashboard environment including a number of widgets and for presenting representations of the widgets in a viewer disposed on the display, the viewer including one or more controls for scrolling through the representations of the widgets.

22. The device of claim 1, wherein the display includes a configuration bar for presenting and interacting with the widget.

23. The device of claim 22, wherein open or closed widgets can be scrolled in the display.

24. The device of claim 22, wherein widgets can be scrolled on the display in multiple directions.

25. A method, comprising:
configuring a dashboard and one or more widgets to operate on a portable device; and
presenting the one or more widgets on a display of the device based on the display type.

26. The method of claim 25, wherein the display is the dashboard and the one or more widgets are presented on the dashboard.

27. The method of claim 26, further comprising:
determining the display type from information provided by the device.

28. The method of claim 26, further comprising:
determining the display type from information received over a network or bus.

29. The method of claim 26, wherein presenting further comprises:
displaying the widget in a parade with other widgets.

30. The method of claim 26, wherein presenting further comprises:
displaying the widget in a viewer.

31. The method of claim 26, wherein presenting further comprises:
displaying an active widget in a configuration bar.

32. The method of claim 26, further comprising:
receiving input specifying a widget from a number of widgets presented on a display of the device; and
flipping the widget in response to the input to expose a flip side of the widget and presenting information on the flip side.

33. A device, comprising:
a processor; and
a computer-readable medium operatively coupled to the processor for storing instructions, which, when executed by the processor, causes the processor to generate a dashboard environment, wherein the dashboard environment is configured based on limitations or attributes of the device.

34. The device of claim 33, wherein the device is from a group of devices consisting of a mobile phone, a computer, a personal digital assistant, a media player, a tablet, a remote control and a wearable item.

35. A method, comprising:
connecting a device to a network;
receiving dashboard configuration information for creating a dashboard environment on the device; and
generating the dashboard environment on the device using the configuration information, wherein the configuration information is based on a characteristic of the device.

36. A device, comprising:
a processor; and
a computer-readable medium operatively coupled to the processor and storing a data structure, the data structure configurable for providing access to dashboard or widget information from a dashboard or widget operating on the device, wherein the information conforms to a predetermined syntax.

37. A device, comprising:
a processor; and
a computer-readable medium operatively coupled to the processor and storing a data structure, the data structure configurable for providing access to device information to a dashboard or widget operating on the device, wherein the information conforms to a predetermined syntax.

38. A computer-readable medium having instructions stored thereon, which, when executed by a processor, causes the processor to perform operations, comprising:
generating a data structure operable for providing access to dashboard or widget information from a dashboard or widget operating on a device, wherein the information conforms to a predetermined syntax.

39. A computer-readable medium having instructions stored thereon, which, when executed by a processor, causes the processor to perform operations, comprising:
generating a data structure operable for providing access to device information to a dashboard or widget operating on the device, wherein the information conforms to a predetermined syntax.
